(19) United States
(12) Patent Application Publication
(10) Pub. No.: US 2008/0308982 A1
(43) Pub. Date: Dec. 18, 2008

(54) X-Y TABLE

(76) Inventor: Colin Keith Weston, Dundas (CA)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(21) Appl. No.: 12/104,896

(22) Filed: Apr. 17, 2008

(30) Foreign Application Priority Data
Apr. 17, 2007 (US) PCT/US2007/000620

(51) Int. Cl. B23Q 3/18

(52) U.S. Cl. 269/58

(57) ABSTRACT

An X-Y table for carrying a workpiece in an X-Y plane comprises a base member with a work table mounted in supported relation on the base member so as to be independently movable in an X-direction and a Y-direction in an X-Y plane. There is an X direction drive motor for selectively moving the work table in the X direction in the X Y plane. The X direction drive motor is connected to the work table in movable relation in the Y direction to thereby accommodate movement of the work table in the Y direction. There is also a Y direction drive motor for selectively moving the work table in the Y direction in the X Y plane. The Y direction drive motor is connected to the work table in movable relation in the X direction to thereby accommodate movement of the work table in the X direction.

### FIELD OF THE INVENTION

The present invention relates to X-Y tables, and more particularly to X-Y tables that are selectively movable in a plane.

### BACKGROUND OF THE INVENTION

Two axis work tables for machining workpieces, or for performing other operations, such as applying adhesive, and so on, to workpieces, have been known for many years. There are many varieties of such two axis work tables; however, they all share one common fundamental and significant drawback. In order to achieve independent two axis movement, with the two axes (conventionally referred to as the X axis and the Y axis) being perpendicular one to the other, a first table is mounted in slidably moveable relation on a base member and the second table is mounted in slidably moveable relation on the first table. A workpiece is mounted on the second table. The first table is movable with respect to the base member along the X-axis. The second table is movable with respect to the first table along the Y-axis. The movement of the first table along the X-axis is independent from the movement of the second table along the Y-axis.

In order to move a workpiece situated on the second table, both the first table and the second table must be moved. Further, the drive means, such as an electric motor, for driving the second table with respect to the first table, is typically mounted on the first table and must be carried therewith, which is highly undesirable as such electric motors are typically heavy. Further, all of the electric wiring, and any other cables or tubes, and the like, must be carried with the movement of the first table. Such an arrangement is unnecessarily complicated and expensive.

One example of such a prior art X-Y table is found U.S. Pat. No. 6,220,799 issued Apr. 24, 2001 to Okutani et al and entitled Machine Tool. A Y-axis table is slidably mounted on rails on a base member for movement in a Y direction. An X-axis table is mounted on the Y-axis table for movement in an X-direction. Further, the electric drive motor, the rigid drive shaft are mounted on the Y-axis table by means of cumbersome mounting posts, all of which must be carried by the Y-axis table.

It is an object of the present invention to provide a two axis X-Y work table having a single table member.

It is another object of the present invention to provide a two axis X-Y work table having a single table member, which two axis X-Y work table is uncomplicated.

It is another object of the present invention to provide a two axis X-Y work table having a single table member, which two axis X-Y work table is inexpensive to manufacture.

It is a further object of the present invention to provide a two axis X-Y work table having a single table member, which two axis X-Y work table can be used in a variety of applications.

### SUMMARY OF THE INVENTION

In accordance with one aspect of the present invention there is disclosed a novel X-Y table for carrying a workpiece in an X-Y plane. The X-Y table comprises a base member, and a work table mounted in supported relation on the base member so as to be independently movable in an X-direction and a Y-direction in an X-Y plane. There is an X-direction drive means for selectively moving the work table in the X-direction in the X-Y plane. The X-direction drive means is connected to the work table in movable relation in the Y-direction to thereby accommodate movement of the work table in the Y-direction. There is also a Y-direction drive means for selectively moving the work table in the Y-direction in the X-Y plane. The Y-direction drive means is connected to the work table in movable relation in the X-direction to thereby accommodate movement of the work table in the X-direction.

In accordance with another aspect of the present invention there is disclosed a novel X-Y table for carrying a workpiece in an X-Y plane. The X-Y table comprises a base member, an X-direction drive means operatively mounted on the base member, and a Y-direction drive means operatively mounted on the base member. A work table is mounted in supported relation on the X-direction drive means and the Y-direction drive means, so as to be independently movable in the X-direction and the Y-direction in an X-Y plane. The X-direction drive means is for selectively moving the work table in the X-direction in the X-Y plane wherein the X-direction drive means is connected to the work table in movable relation in the Y-direction to thereby accommodate movement of the work table in the Y-direction. The Y-direction drive means is for selectively moving the work table in the Y-direction in the X-Y plane wherein the Y-direction drive means is connected to the work table in movable relation in the X-direction to thereby accommodate movement of the work table in the X-direction.

In accordance with another aspect of the present invention there is disclosed a novel X-Y table for carrying a workpiece in an X-Y plane. The X-Y table comprises a base member, with a work table mounted in supported relation on the base member so as to be independently movable in an X-direction and a Y-direction in an X-Y plane. The work table has an X-Y cross-cut gear rack. An X-direction drive gear engages the X-Y cross-cut gear rack, for selectively moving the work table in the X-direction in the X-Y plane as the X-direction drive gear rotates. A Y-direction drive gear engages the X-Y cross-cut gear rack, for selectively moving the work table in the Y-direction in the X-Y plane as the Y-direction drive gear rotates. The X-direction drive gear slides across the work table in the Y-direction the to permit relative movement in the Y-direction of the work table with respect to the X-direction drive gear. The Y-direction drive gear slides across the work table in the X-direction the to permit relative movement in the X-direction of the work table with respect to the Y-direction drive gear.

In accordance with another aspect of the present invention there is disclosed a novel X-Y table for carrying a workpiece in an X-Y plane. The X-Y table comprises a base member, an X-direction drive gear operatively mounted on the base member, and a Y-direction drive gear operatively mounted on the base member. A work table is mounted in supported relation on the X-direction drive gear and the Y-direction drive gear, so as to be independently movable in the X-direction and the Y-direction in an X-Y plane, the work table having an X-Y cross-cut gear rack. The X-direction drive gear engages the X-Y cross-cut gear rack, and is for selectively moving the work table in the X-direction in the X-Y plane as the X-direction drive gear rotates. The Y-direction drive gear engages the X-Y cross-cut gear rack, and is for selectively moving the work table in the Y-direction in the X-Y plane as the Y-direction drive gear rotates. The X-direction drive gear slides across the work table in the Y-direction the to permit relative movement in the Y-direction of the work table with respect to the X-direction drive gear. The Y-direction drive gear slides across the work table in the X-direction the to permit relative movement in the X-direction of the work table with respect to the Y-direction drive gear.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the X-Y table according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view of the first preferred embodiment of the X-Y table according to the present invention;

FIG. 2 is a perspective view of the first preferred embodiment of the X-Y table of FIG. 1, with the work table having moved in the X-direction and in the Y-direction;

FIG. 3 is a side elevational view of the first preferred embodiment of the X-Y table of FIG. 1;

FIG. 4 is a perspective view of the first preferred embodiment of the X-Y table of FIG. 1, with the work table removed for the sake of clarity;

FIG. 5 is a perspective view of the first preferred embodiment of the X-Y table of FIG. 1;

FIG. 6 is a side elevational view of a second preferred embodiment X-Y table according to the present invention;

FIG. 7 is a perspective view of the third preferred embodiment of the X-Y table according to the present invention;

FIG. 8 is a perspective view of the drive gears of the third preferred embodiment X-Y table of FIG. 7;

FIG. 9 is a top plan view of a fourth preferred embodiment of the X-Y table according to the present invention;

FIG. 10 is a perspective view of the fifth preferred embodiment of the X-Y table according to the present invention;

FIG. 11 is a perspective view of the sixth preferred embodiment of the X-Y table according to the present invention;

FIG. 12 is a perspective view of a seventh preferred embodiment of the X-Y table of the present invention, in use in conjunction with a conveyor system;

FIG. 13 is a perspective view of the eighth preferred embodiment of the X-Y table according to the present invention;

FIG. 14 is a perspective view of a belt assembly used in the seventh preferred embodiment X-Y table of FIG. 12;

FIG. 15 is a perspective view of the ninth preferred embodiment of the X-Y table according to the present invention;

FIG. 16 is a top plan view of a portion of the ninth preferred embodiment of the X-Y table of FIG. 15;

FIG. 17 is a perspective view of the tenth preferred embodiment of the X-Y table according to the present invention; and,

FIG. 18 is a perspective view of the eleventh preferred embodiment of the X-Y table according to the present invention, with the work table removed for the sake of clarity.

### DETAILED DESCRIPTION OF THE PREFERRED EMBODIMENTS

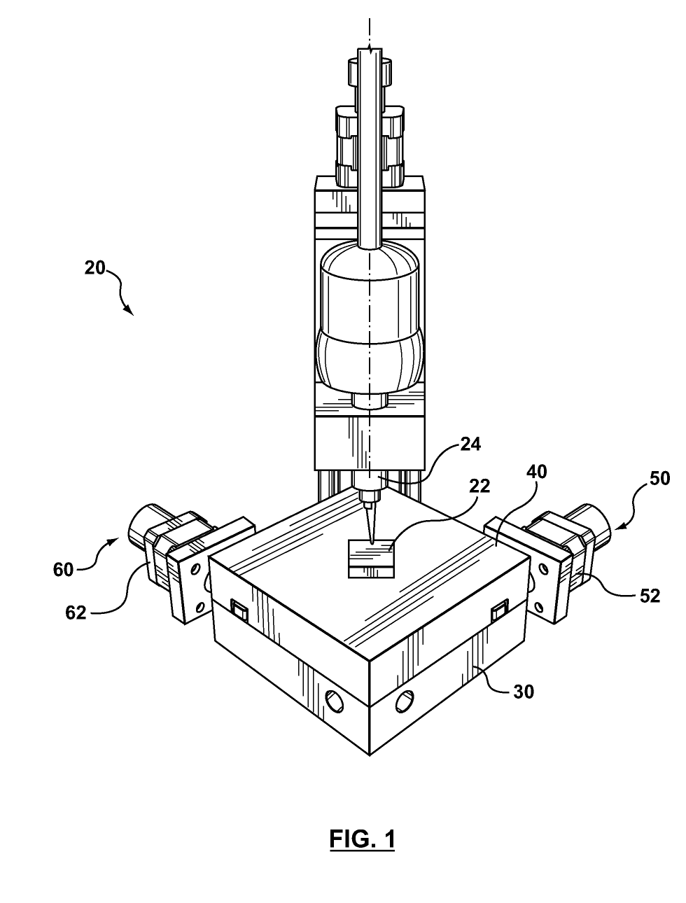

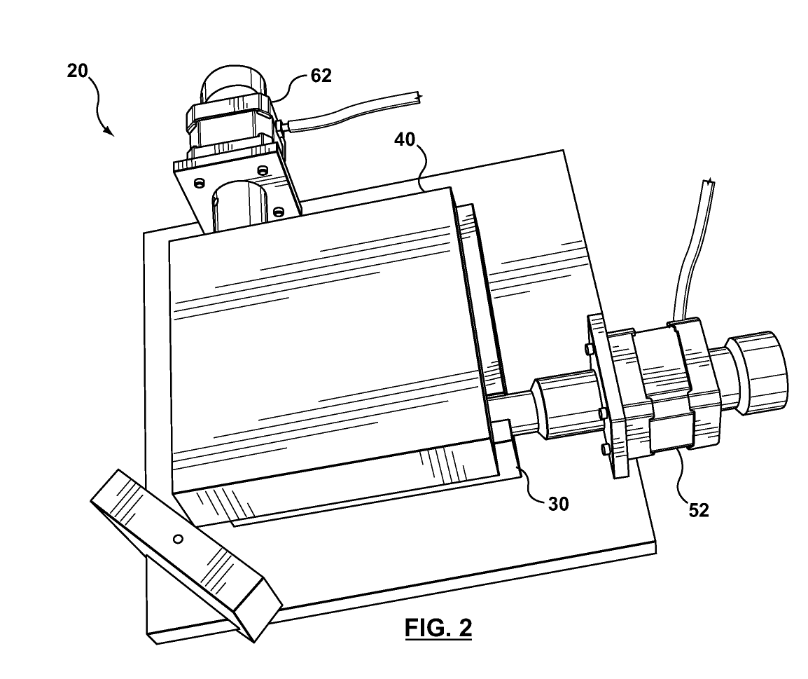

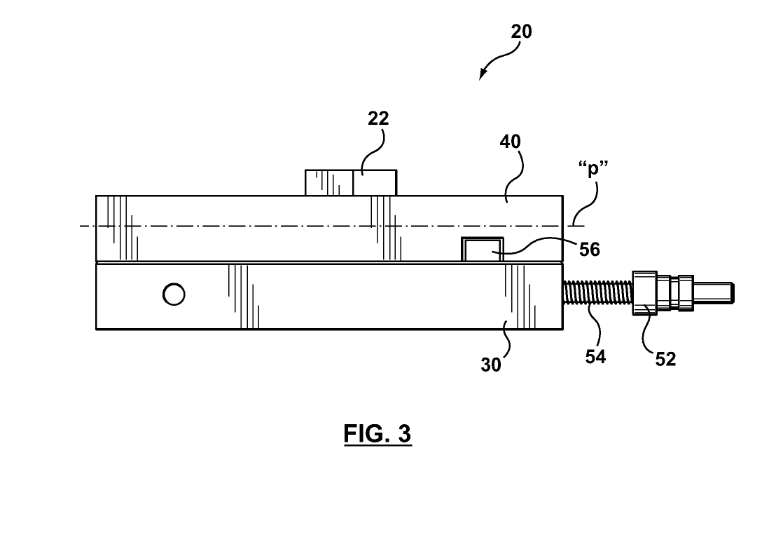

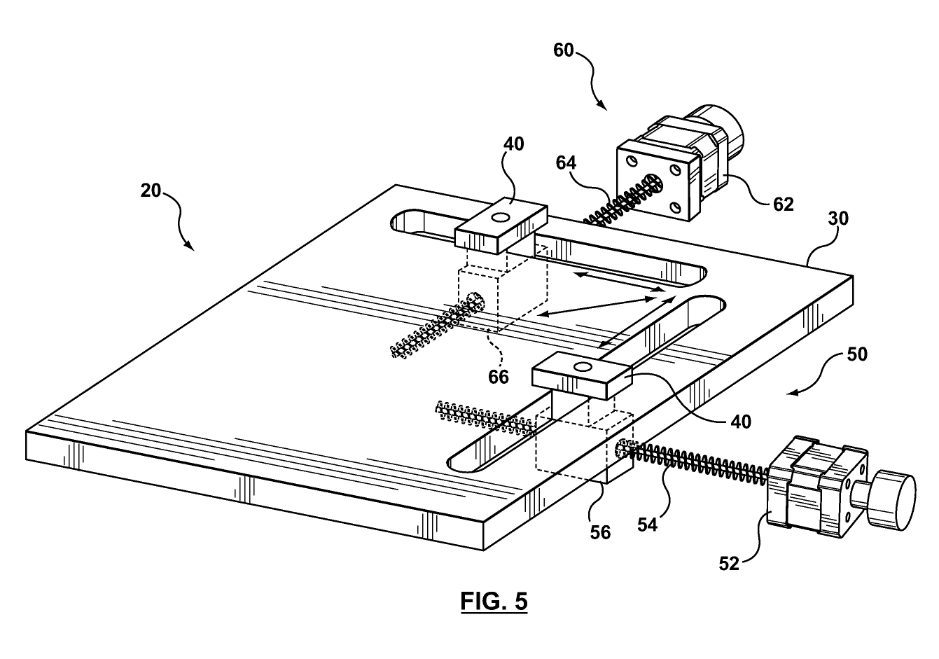

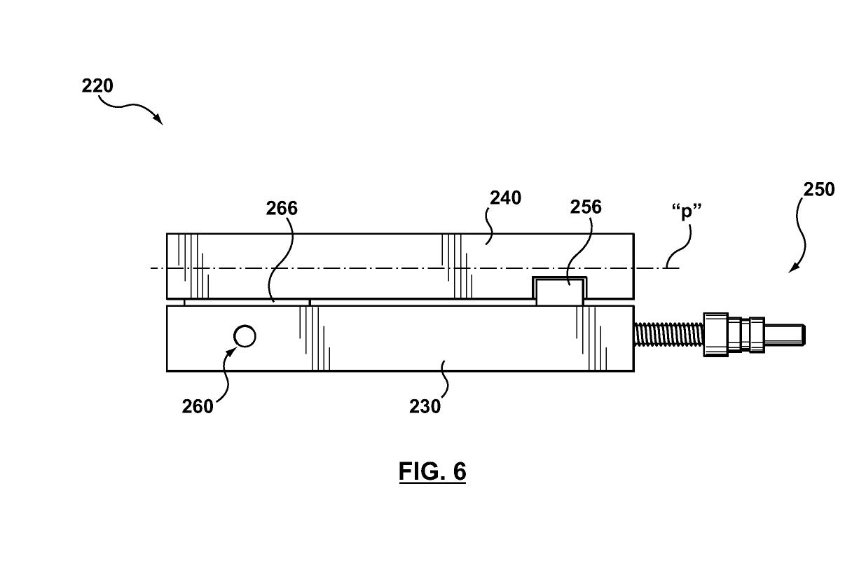

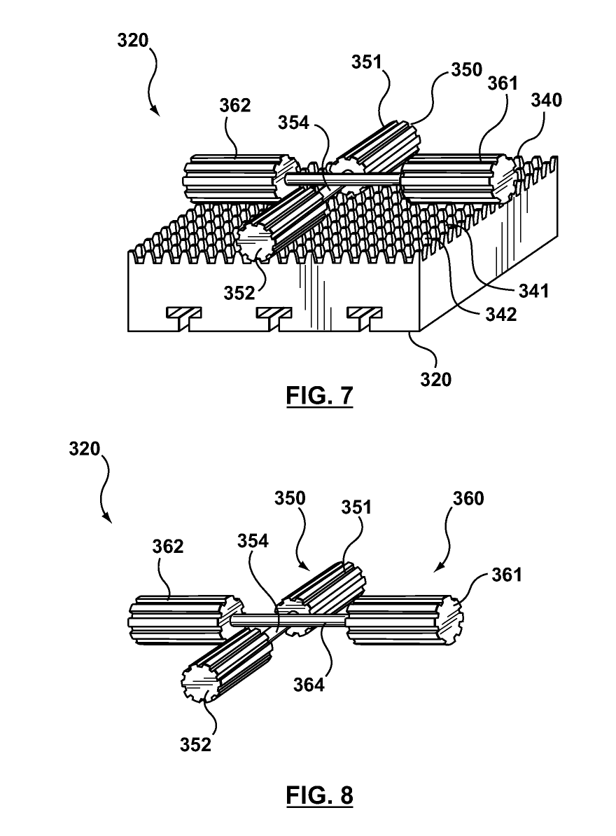

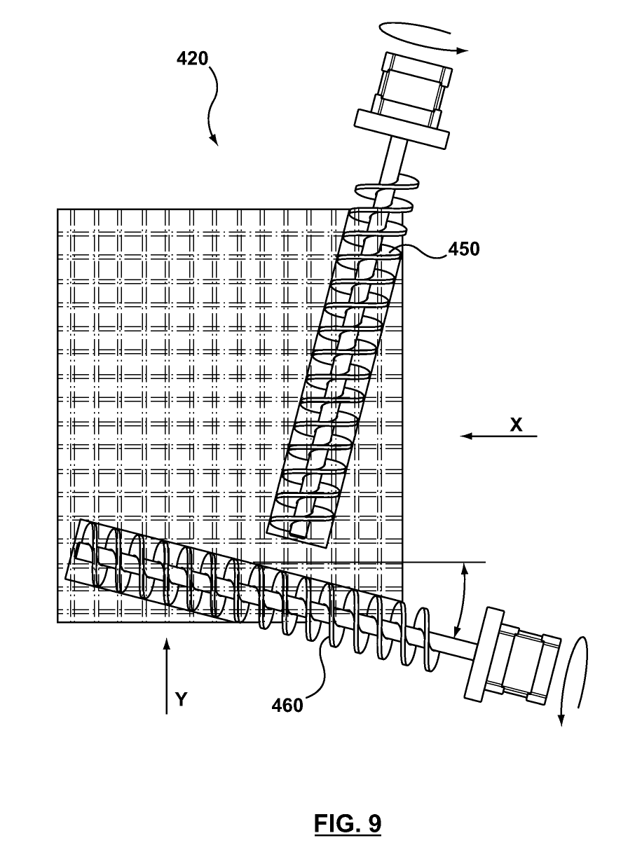

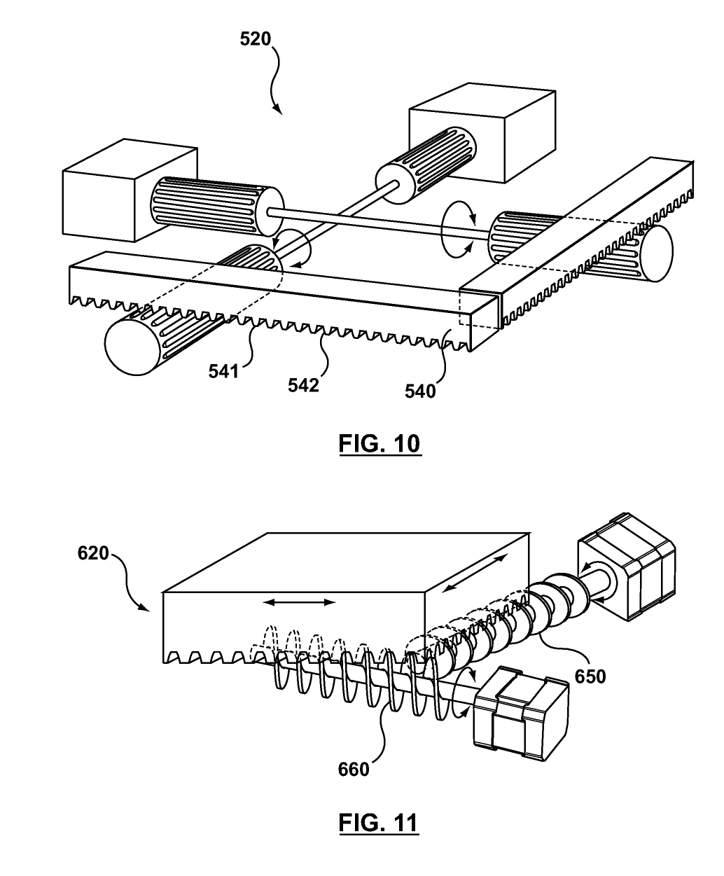

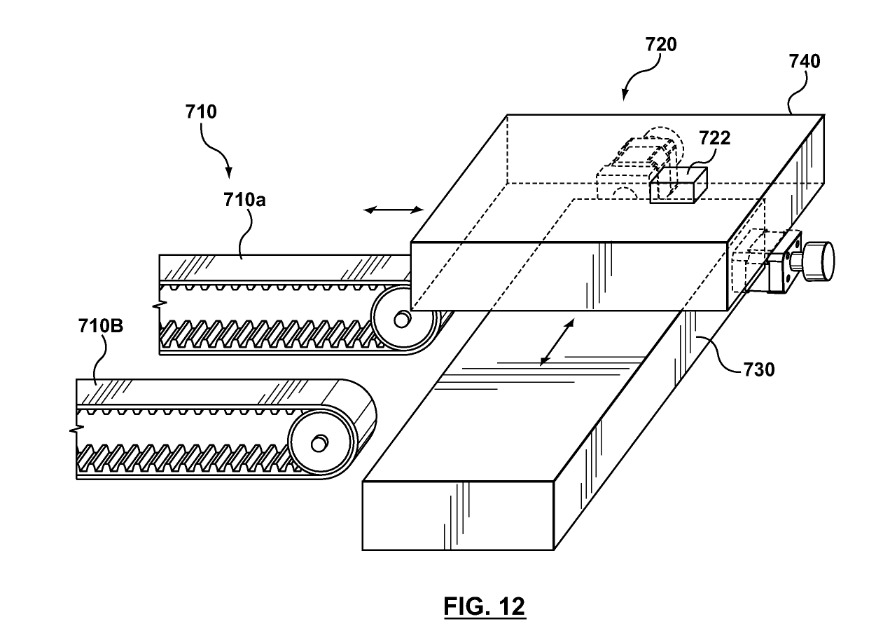

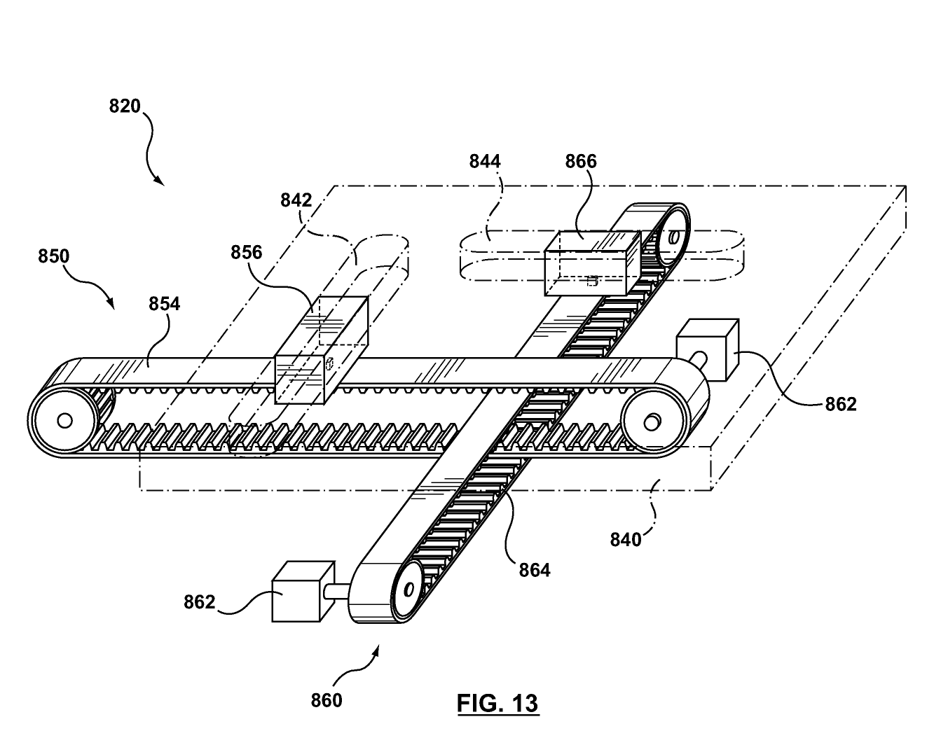

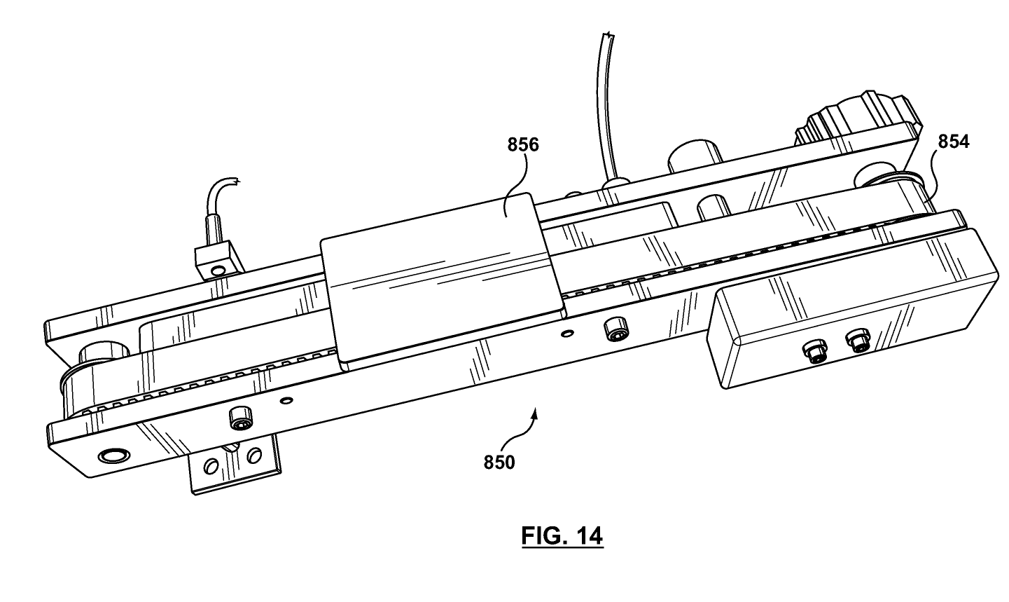

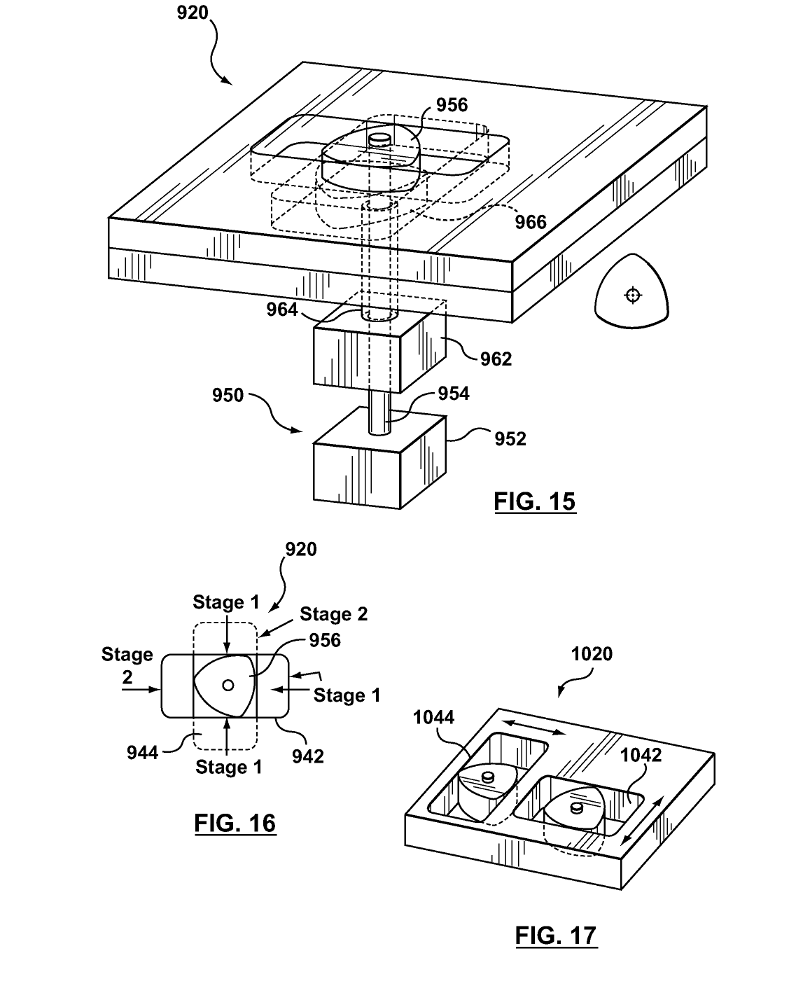

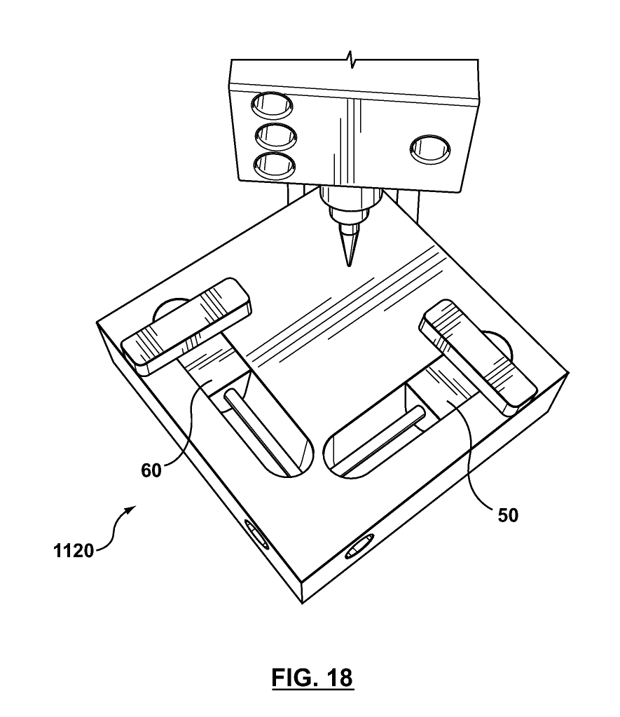

Referring to FIGS. 1 through 18 of the drawings, it will be noted that FIGS. 1 through 5 illustrate a first preferred embodiment of the X-Y table of the present invention, FIG. 6 illustrates a second preferred embodiment of the X-Y table of the present invention, and FIGS. 7 and 8 illustrate a third preferred embodiment of the X-Y table of the present invention, FIG. 9 illustrates a fourth preferred embodiment of the X-Y table of the present invention, FIG. 10 illustrates a fifth preferred embodiment of the X-Y table of the present invention, FIG. 11 illustrates a sixth preferred embodiment of the X-Y table of the present invention, FIG. 12 illustrates a seventh preferred embodiment of the X-Y table of the present invention, FIGS. 13 and 14 illustrate a eighth preferred embodiment of the X-Y table of the present invention, FIGS. 15 and 16 illustrate a ninth preferred embodiment of the X-Y table of the present invention, FIG. 17 illustrates a tenth preferred embodiment of the X-Y table of the present invention, and FIG. 18 illustrates an eleventh preferred embodiment of the X-Y table of the present invention.

Reference will now be made to FIGS. 1 through 5, which show a first preferred embodiment of the X-Y table of the present invention, as indicated by general reference numeral 20. The X-Y table 20 is for carrying a workpiece 22 and moving it about in a plane “P”, so that the workpiece 22 can be worked on, by a selected apparatus or device, such as an adhesive applicator 24, as is shown in the first preferred embodiment, or any other selected apparatus or device. As illustrated, the plane “P” is a substantially horizontal plane, but may be oriented at any desired angle. Typically, if the plane “P” is oriented off-horizontal by a significant amount, then the workpiece 22 would need to be fastened, or secured in some suitable manner.

The X-Y table 20 comprises a base member 30 for operatively supporting most or all of the components of the X-Y table 20. The base member 30 is preferably made from metal for the sake of strength and durability, but could be made from any other suitable material.

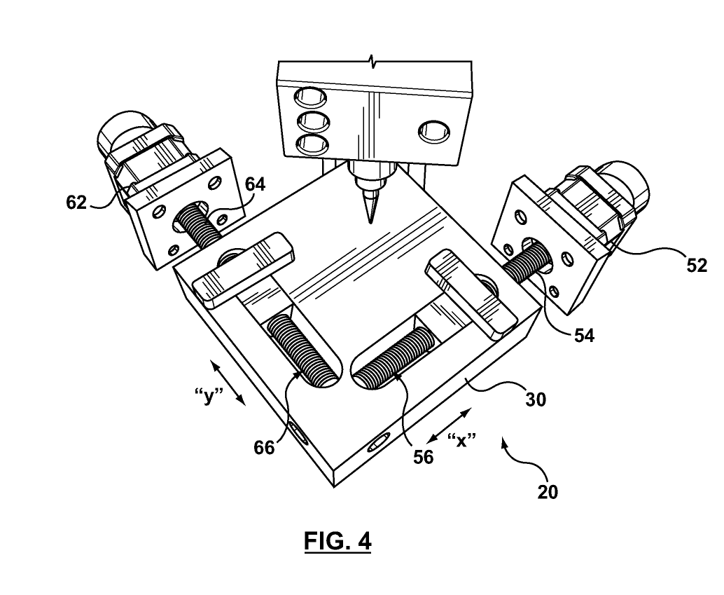

A work table 40 is mounted in supported relation on the base member 30 so as to be independently movable in an X-direction, as indicated by arrow “X” in FIG. 4, and in a Y-direction, as indicated by arrow “Y” in FIG. 4. The independent movements in the X-direction and the Y-direction are in an X-Y plane, and vectorially add to an overall desired movement of the work table 40.

The work table 40 is preferably made from metal for the sake of strength and durability, but could be made from plastic or a composite material, for the sake of reduced mass, or from any other suitable material.

There is an X-direction drive means 50 for selectively moving the work table 40 in the X-direction in the X-Y plane. There is also a Y-direction drive means 60 for selectively moving the work table 40 in the Y-direction in the X-Y plane. In the first preferred embodiment, the X-direction drive means 50 comprises a first electric motor 52, a first elongate threaded drive shaft 54, and a first tongue member 56. Similarly, the Y-direction drive means 60 comprises a second electric motor 62, a second elongate threaded drive shaft 64, and a second tongue member 66. Alternatively, the X-direction drive means 50 and the Y-direction drive means 60 could each include a pneumatic motor, or any other suitable drive means.

The work table 40 includes an X-direction drive slot 42 oriented in the Y-direction to receive the X-direction drive means 50, specifically the first tongue member 56, and a Y-direction drive slot 44 oriented in the X-direction to receive the Y-direction drive means 60, specifically the second tongue member 66. The purpose of the X-direction drive slot and the Y-direction drive slot will be set forth subsequently.

The X-direction drive means 50 is connected to the work table 40 in movable relation in the Y-direction to thereby accommodate movement of the work table 40 in the Y-direction. The first tongue member 56 of the X-direction drive means 50 is slidably engaged in the X-direction drive slot 42 in the work table 40. The first electric motor 52 is operatively connected to the first tongue member 56 by means of the first elongate threaded drive shaft 54 that is rotated by the first electric drive motor. As the first electric drive motor 52 is powered so as to rotate, the first elongate threaded drive shaft 54 rotates therewith, and accordingly moves the first tongue member 56 in the X-direction, to thereby urge the work table 40 in the X-direction.

The Y-direction drive means is connected to the work table 40 in movable relation in the X-direction to thereby accommodate movement of the work table 40 in the X-direction. The second tongue member 66 of the Y-direction drive means 60 is slidably engaged in the Y-direction drive slot 44 in the work table 40. The second electric drive motor 62 is operatively connected to the second tongue member 66 by means of the second elongate threaded drive shaft 64 that is rotated by the second electric drive motor 62. As the second electric drive motor is powered so as to rotate, the second elongate threaded drive shaft 64 rotates therewith, and accordingly moves the second tongue member 66 in the Y-direction, to thereby urge the work table 40 in the Y-direction.

As can be readily discerned from the description and the figures, when the X-direction drive means 50, namely the first electric motor 52, the first elongate threaded drive shaft 54 and the first tongue member 56, moves the work table 40 in the X-direction, the work table 40 is still free to move in the Y-direction, by means of the first tongue member 56 sliding in the X-direction drive slot 42, which is oriented in the Y-direction. Similarly, when the Y-direction drive means 60, namely the second electric motor 62, the second elongate threaded drive shaft 64 and the second tongue member 66, moves the work table 40 in the Y-direction, the work table 40 is still free to move in the X-direction, by means of the second tongue member 66 sliding in the Y-direction drive slot 44, which is oriented in the X-direction.

The X-Y table 20 further comprises means 70 for controlling the X-direction drive means and the Y-direction drive means, to thereby permit selected movement of the work table 40 in the X-Y plane. In the first preferred embodiment, as illustrated, the means 70 for controlling the X-direction drive means and the Y-direction drive means comprises a digital electronic control module 70.

Reference will now be made to FIG. 6, which shows a second preferred embodiment of the X-Y table of the present invention, as indicated by general reference numeral 220. The second preferred embodiment X-Y table 220 is similar to the first preferred embodiment X-Y table 20 except that the work table 240 is not mounted in supported relation on the base member 230. Instead, the work table is mounted in supported relation on the X-direction drive means 250, specifically the first tongue member 256, and said Y-direction drive means 260, specifically the second tongue member 266, so as to be independently movable in the X-direction and the Y-direction in the X-Y plane “P”.

Reference will now be made to FIGS. 7 and 8, which show a third preferred embodiment of the X-Y table of the present invention, as indicated by general reference numeral 320. The third preferred embodiment X-Y table 320 is similar to the first preferred embodiment X-Y table 20 except that the work table 340 comprises a top surface 341 and a cross-cut gear rack 342 disposed on the top surface 341. An X-direction drive gear 350 engages the X-Y cross-cut gear rack 342, for selectively moving the work table 340 in the X-direction in the X-Y plane as the X-direction drive gear 350 rotates. A Y-direction drive gear 360 engages the X-Y cross-cut gear rack 342, for selectively moving the work table 340 in the Y-direction in the X-Y plane as the Y-direction drive gear 360 rotates. The X-direction drive gear 350 slides across the work table 340 in the Y-direction the to permit relative movement in the Y-direction of the work table 340 with respect to the X-direction drive gear 350. Similarly, the Y-direction drive gear 360 slides across the work table 340 in the X-direction the to permit relative movement in the X-direction of the work table 340 with respect to the Y-direction drive gear 360.

In the third preferred embodiment, as illustrated, the X-direction drive gear 350 comprises a first drive gear member 351 and a second drive gear member 352 joined together for concurrent axial rotation by means of a shaft member 354. Similarly, Y-direction drive gear 360 comprises a first drive gear member 361 and a second drive gear member 362 joined together for concurrent axial rotation by means of a shaft member 364. The shaft member 354 of the X-direction drive gear 350 and the shaft member 354 of the Y-direction drive gear 360 overlap each other, to permit the X-direction drive gear 350 and the Y-direction drive gear 360 to span the entire size of the work table 340. The first drive gear member 351 and the second drive gear member 352 are larger in diameter than are the first drive gear member 361 and the second drive gear member 362, so that the shaft member 354 and the shaft member 364 are offset one from the other.

Reference will now be made to FIG. 9, which shows a fourth preferred embodiment of the X-Y table of the present invention, as indicated by general reference numeral 420. The fourth preferred embodiment X-Y table 420 is similar to the third preferred embodiment X-Y table 320 except that the X-direction drive gear 450 comprises a first worm gear oriented with respect to the X-direction at an angle equal to the pitch of the first worm gear 450. Also, the Y-direction drive gear 460 comprises a second worm gear oriented with respect to the Y-direction at an angle equal to the pitch of the second worm gear 460.

Reference will now be made to FIG. 10, which shows a fifth preferred embodiment of the X-Y table of the present invention, as indicated by general reference numeral 520. The fifth preferred embodiment X-Y table 520 is similar to the third preferred embodiment X-Y table 320 except that the cross-cut gear rack 542 is disposed on the bottom surface 541 of the work table 540.

Reference will now be made to FIG. 11, which shows a sixth preferred embodiment of the X-Y table of the present invention, as indicated by general reference numeral 620. The sixth preferred embodiment X-Y table 620 is similar to the fifth preferred embodiment X-Y table 520 except that the X-direction drive gear 650 comprises a first worm gear oriented with respect to the X-direction at an angle equal to the pitch of the first worm gear 650. Also, the Y-direction drive gear 660 comprises a second worm gear oriented with respect to the Y-direction at an angle equal to the pitch of the second worm gear 660.

Reference will now be made to FIG. 12, which shows a seventh preferred embodiment of the first preferred embodiment X-Y table, as indicated by the general reference numeral 720. It can readily be seen that is usable directly in conjunction with a conveyor system, as indicated by the general reference numeral 710, for moving the work table 740 on and off the base member 730. The X-Y table 720 is elongate along the X-axis and has two conveyors 710a and 710b oriented perpendicularly to the X-Y table 720 having their ends disposed adjacent to the X-Y table 720 to permit feeding of the work table 740 onto the base member 730 and removal of the work table 740 from the base member 730. The X-Y table 720 is configured analogously to the first preferred embodiment X-Y table 20, and has an X-direction drive means 750 that uses a first tongue member 756 to drive the work table 740 in the X-direction, and a Y-direction drive means 760 that uses a second tongue member 766 to drive the work table 740 in the Y-direction. In addition to the work table 740 being moved around the base member by the X-direction drive means 750 and the Y-direction drive means 760, the X-direction drive means can have the work table 740 to be in alignment with either of the conveyors 710a and 710b, and the Y-direction drive means 760 can move the work table 740 on and off each of the conveyors 710a and 710b.

Reference will now be made to FIGS. 13 and 14, which show an eighth preferred embodiment of the X-Y table of the present invention, as indicated by general reference numeral 820. The seventh preferred embodiment X-Y table 820 is similar to the first preferred embodiment X-Y table 20 except that the X-drive means 850 comprises a belt member 854 driven by an electric motor 852. The belt member 854 has teeth 858 that engage co-operating slots or teeth (not shown) in the bottom surface 857 of the first tongue member 856. Similarly, Y-drive means 860 comprises a belt member 864 driven by an electric motor 862. The belt member 864 has teeth 868 that engage co-operating slots or teeth (not shown) in the bottom surface 867 of the second tongue member 866. FIG. 14 shows the X-direction drive means separately.

Reference will now be made to FIGS. 15 and 16, which show a ninth preferred embodiment of the X-Y table of the present invention, as indicated by general reference numeral 920. The ninth preferred embodiment X-Y table 920 is similar to the first preferred embodiment X-Y table 20 except that X-direction drive means 950 comprises an electric motor 952 driving a drive shaft 954 with a cam member 956 mounted on the drive shaft 954 for rotation therewith. The cam member 956 is engaged in an X-direction drive slot 942 in the work table 940. Similarly, the Y-direction drive means 960 comprises an electric motor 962 driving a drive shaft 964 with a cam member 966 mounted on the drive shaft for rotation therewith. The cam member 966 is engaged in a Y-direction drive slot 944 in the work table 940. The X-direction drive slot 942 is immediately above the Y-direction drive slot 944.

Reference will now be made to FIG. 17, which shows a tenth preferred embodiment of the X-Y table of the present invention, as indicated by general reference numeral 1020. The tenth preferred embodiment X-Y table 1020 is similar to the ninth preferred embodiment X-Y table 920 except that the X-direction drive slot 1042 and the Y-direction drive slot 1044 are offset one from the other.

Reference will now be made to FIG. 18, which shows an eleventh preferred embodiment of the X-Y table of the present invention, as indicated by general reference numeral 1120. The eleventh preferred embodiment X-Y table 1120 is similar to the first preferred embodiment X-Y table 20 except that the X-direction drive means 1150 comprises a linear motor and the Y-direction drive means 1160 comprises a linear motor.

As can be understood from the above description and from the accompanying drawings, the present invention provides a two axis X-Y work table having a single table member, which two axis X-Y work table is uncomplicated, is inexpensive to manufacture, and which two axis X-Y work table can be used in a variety of applications, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the X-Y table of the present invention without departing from the spirit and scope of the accompanying claims.

I claim:

1. An X-Y table for carrying a workpiece in an X-Y plane, said X-Y table comprising:
a base member;
a work table mounted in supported relation on said base member so as to be independently movable in an X-direction and a Y-direction in an X-Y plane;
X-direction drive means for selectively moving said work table in said X-direction in said X-Y plane, wherein said X-direction drive means is connected to said work table in movable relation in said Y-direction to thereby accommodate movement of said work table in said Y-direction; and,
Y-direction drive means for selectively moving said work table in said Y-direction in said X-Y plane, wherein said Y-direction drive means is connected to said work table in movable relation in said X-direction to thereby accommodate movement of said work table in said X-direction.

2. The X-Y table of claim 1, further comprising means for controlling said X-direction drive means and said Y-direction drive means, to thereby permit selected movement of said work table in said X-Y plane.

3. The X-Y table of claim 1, wherein said work table includes an X-direction drive slot oriented in said Y-direction to receive said X-direction drive means therein, and a Y-direction drive slot oriented in said X-direction to receive said Y-direction drive means therein.

4. The X-Y table of claim 3, wherein said X-direction drive means comprises a first tongue member slidably engaged in said X-direction drive slot in said work table, and said Y-direction drive means comprises a second tongue member slidably engaged in said Y-direction drive slot in said work table.

5. The X-Y table of claim 1, wherein said X-direction drive means comprises a first electric motor, and said Y-direction drive means comprises a second electric motor.

6. The X-Y table of claim 5, wherein said first electric motor is operatively connected to said first tongue member by means of a first elongate threaded drive shaft, and said second electric drive motor is operatively connected to said second tongue member by means of a second elongate threaded drive shaft.

7. An X-Y table for carrying a workpiece in an X-Y plane, said X-Y table comprising:
a base member;
X-direction drive means operatively mounted on said base member;
Y-direction drive means operatively mounted on said base member;
a work table mounted in supported relation on said X-direction drive means and said Y-direction drive means, so as to be independently movable in said X-direction and said Y-direction in an X-Y plane;
wherein said X-direction drive means is for selectively moving said work table in said X-direction in said X-Y plane wherein said X-direction drive means is connected to said work table in movable relation in said Y-direction to thereby accommodate movement of said work table in said Y-direction;
wherein said Y-direction drive means is for selectively moving said work table in said Y-direction in said X-Y plane wherein said Y-direction drive means is connected to said work table in movable relation in said X-direction to thereby accommodate movement of said work table in said X-direction.

8. The X-Y table of claim 7, further comprising means for controlling said X-direction drive means and said Y-direction drive means, to thereby permit selected movement of said work table in said X-Y plane.

9. The X-Y table of claim 7, wherein said work table includes an X-direction drive slot oriented in said Y-direction to receive said X-direction drive means therein, and a Y-direction drive slot oriented in said X-direction to receive said Y-direction drive means therein.

10. The X-Y table of claim 9, wherein said X-direction drive means comprises a first tongue member slidably engaged in said X-direction drive slot in said work table, and said Y-direction slide means comprises a second tongue member slidably engaged in said X-direction drive slot in said work table.

11. The X-Y table of claim 7, wherein said X-direction drive means comprises a first electric motor, and said Y-direction drive means comprises a second electric motor.

12. The X-Y table of claim 11, wherein said first electric motor is operatively connected to said first tongue member by means of a first elongate threaded drive shaft, and said second electric drive motor is operatively connected to said second tongue member by means of a second elongate threaded drive shaft.

13. The X-Y table of claim 1, wherein said X-direction drive means comprises a linear motor and the Y-direction drive means comprises a linear motor.

14. An X-Y table for carrying a workpiece in an X-Y plane, said X-Y table comprising:
a base member;
a work table mounted in supported relation on said base member so as to be independently movable in an X-direction and a Y-direction in an X-Y plane, said work table having an X-Y cross-cut gear rack;
an X-direction drive gear engaging said X-Y cross-cut gear rack, for selectively moving said work table in said X-direction in said X-Y plane as said X-direction drive gear rotates; and,
a Y-direction drive gear engaging said X-Y cross-cut gear rack, for selectively moving said work table in said Y-direction in said X-Y plane as said Y-direction drive gear rotates;
wherein said X-direction drive gear slides across said work table in said Y-direction said to permit relative movement in said Y-direction of said work table with respect to said X-direction drive gear; and,
wherein said Y-direction drive gear slides across said work table in said X-direction said to permit relative movement in said X-direction of said work table with respect to said Y-direction drive gear.

15. The X-Y table of claim 14, wherein said work table comprises a top surface and said cross-cut gear rack is disposed on said top surface.

16. The X-Y table of claim 14, wherein said X-direction drive gear comprises a first drive gear member and a second drive gear member joined together for concurrent axial rotation by means of a shaft member, and Y-direction drive gear comprises a first drive gear member and a second drive gear member joined together for concurrent axial rotation by means of a shaft member.

17. The X-Y table of claim 14, wherein said shaft member of said X-direction drive gear and said shaft member of said Y-direction drive gear overlap each other.

18. The X-Y table of claim 14, further comprising means for controlling said X-direction drive means and said Y-direction drive means, to thereby permit selected movement of said work table in said X-Y plane.

19. The X-Y table of claim 14, wherein said X-direction drive means comprises a first electric motor, and said Y-direction drive means comprises a second electric motor.

20. The X-Y table of claim 14, wherein said X-direction drive gear comprises a first worm gear oriented with respect to said X-direction at an angle equal to its pitch, and wherein said Y-direction drive gear comprises a second worm gear oriented with respect to said Y-direction at an angle equal to its pitch.

21. An X-Y table for carrying a workpiece in an X-Y plane, said X-Y table comprising:
a base member;
an X-direction drive gear operatively mounted on said base member;
a Y-direction drive gear operatively mounted on said base member; and,
a work table mounted in supported relation on said X-direction drive gear and said Y-direction drive gear, so as to be independently movable in said X-direction and said Y-direction in an X-Y plane, said work table having an X-Y cross-cut gear rack;
wherein said X-direction drive gear engages said X-Y cross-cut gear rack, and is for selectively moving said work table in said X-direction in said X-Y plane as said X-direction drive gear rotates;
wherein said Y-direction drive gear engages said X-Y cross-cut gear rack, and is for selectively moving said work table in said Y-direction in said X-Y plane as said Y-direction drive gear rotates;
wherein said X-direction drive gear slides across said work table in said Y-direction said to permit relative movement in said Y-direction of said work table with respect to said X-direction drive gear; and,
wherein said Y-direction drive gear slides across said work table in said X-direction said to permit relative movement in said X-direction of said work table with respect to said Y-direction drive gear.

22. The X-Y table of claim 21, wherein said work table comprises a bottom surface and said cross-cut gear rack is disposed on said bottom surface.

23. The X-Y table of claim 21, wherein said X-direction drive gear comprises a first drive gear member and a second drive gear member joined together for concurrent axial rotation by means of a shaft member, and Y-direction drive gear comprises a first drive gear member and a second drive gear member joined together for concurrent axial rotation by means of a shaft member.

24. The X-Y table of claim 21, wherein said shaft member of said X-direction drive gear and said shaft member of said Y-direction drive gear overlap each other.

25. The X-Y table of claim 21, further comprising means for controlling said X-direction drive means and said Y-direction drive means, to thereby permit selected movement of said work table in said X-Y plane.

26. The X-Y table of claim 21, wherein said X-direction drive means comprises a first electric motor, and said Y-direction drive means comprises a second electric motor.

27. The X-Y table of claim 21, wherein said X-direction drive gear comprises a first worm gear oriented with respect to said X-direction at an angle equal to its pitch, and wherein said Y-direction drive gear comprises a second worm gear oriented with respect to said Y-direction at an angle equal to its pitch.

28. The X-Y table of claim 21, wherein said X-direction drive means comprises a linear motor and the Y-direction drive means comprises a linear motor.
